(19) United States
(12) Patent Application Publication
(10) Pub. No.: US 2016/0016138 A1
(43) Pub. Date: Jan. 21, 2016

(54) COMBINED MICROSPHERE MANUFACTURING APPARATUS

(71) Applicant: METAL INDUSTRIES RESEARCH&DEVELOPMENT CENTRE, KAOHSIUNG (TW)

(72) Inventors: CHENG-HAN HUNG, KAOHSIUNG (TW); YING-CHIEH LIN, KAOHSIUNG (TW); TSAI-FA CHEN, KAOHSIUNG (TW); YEN- TING CHEN, KAOHSIUNG (TW); SHI-ZHEN LIN, KAOHSIUNG (TW); HO-CHUNG FU, KAOHSIUNG (TW)

(21) Appl. No.: 14/541,686

(22) Filed: Nov. 14, 2014

(30) Foreign Application Priority Data
Jul. 15, 2014 (TW) 103124245

(51) Int. Cl. B01J 13/02

(52) U.S. Cl. CPC B01J 13/02

(57) ABSTRACT

A main micro channel layer with a liquid leading-in plate assembled above and a microsphere leading-out plate assembled below. The liquid leading-in plate has a first and two second fluid outlets, and the microsphere leading-out plate has a microsphere outlet. The main micro channel layer has a main, two secondary, and a hybrid micro channels, the main micro channel being communicated with the first fluid outlet, the two secondary micro channels being located at two sides of the main micro channel and intersecting with the main micro channel at an intersection in a cross or a Y junction, the two secondary micro channels communicated with the two second fluid outlets, and the hybrid micro channel connected to the intersection and having an output end. A channel bottom surface of the main micro channel or the two secondary micro channels has an ascending slope to form an inclined inlet.

### CROSS-REFERENCE TO RELATED APPLICATION

This application claims the benefit of Taiwan Patent Application No. 103124245, filed on Jul. 15, 2014, which is hereby incorporated by reference for all purposes as if fully set forth herein.

### BACKGROUND

1. Technical Field

The present invention relates to a combined microsphere manufacturing apparatus, and in particular, to a combined micro sphere manufacturing apparatus with a micro channel of an inclined inlet structure.

2. Related Art

Currently, a microsphere is manufactured at home and abroad by using a conventional method such as an emulsion method or a sol-gel method. In these methods, manufacturing devices such as a granulator, a centrifuge, and a screening machine need to be purchased; as a result, the total cost is excessively high. However, microcapsules and microspheres manufactured by using these expensive devices have poor dispersibility, the embedding effect of the microspheres is not desirable, and a manufacturing process of the microspheres is also complicated. The microspheres are manufactured by using a mechanical stirring method, and the microspheres are naturally formed in a process of even stirring. Disadvantages of the method are that: a size range of the microspheres is excessively large, microspheres within a fixed size range can only be obtained by screening, and spheres that do not meet the specification are equal to waste; the reaction efficiency is poor; and the manufacturing process is tediously long.

In recent years, a micro channel control technology, namely a microsphere technology with droplet control and a controllable particle diameter, develops rapidly and brings about another new technical platform. The micro channel control technology has the advantages of good controllability, high reaction efficiency, a short process time, a simple operation, batch production, expansion of small factories, and the like.

Taiwan Publication No. 1301422 entitled “METHOD AND APPARATUS FOR MANUFACTURING CARRIER MICROSPHERES OF PRESOLIDIFICATION” and Publication No. 1384999 entitled “MANUFACTURING METHOD OF CARRIER AND DEVICE FOR CARRIER” both relate to a detachable micro channel apparatus characterized by fast assembly. FIG. 1 is a schematic diagram of the Publication No. 1384999. A carrier thereof includes a base plate 1, where the base plate 1 is formed by stacking a first base plate 11 into which liquid can be injected, a second base plate 12 that has a structure of a cross-junction diverging channel 121 and can process liquid to form a microsphere, and a third base plate 13 that can output a manufactured microsphere. Layers are fastened onto each other by using screws. A particle diameter of a microsphere manufactured by using the foregoing technology is approximately above 100 μm. When Y-junction or cross-junction diverging channels converge, an injection flow speed cannot ensure a smooth sliding flow, and in addition, membrane thickness cannot be controlled by the flow speed.

### SUMMARY

An objective of the present invention is to provide a hybrid micro channel with an inclined inlet, and is further to provide a microsphere manufacturing apparatus that can adjust a size of a microsphere particle by controlling a flow speed of an injection fluid.

To achieve the foregoing objective, the combined microsphere manufacturing apparatus in the present invention includes a main micro channel layer assembled between a liquid leading-in plate and a microsphere leading-out plate. The main micro channel layer comprises a main micro channel, two secondary micro channels, and a hybrid micro channel. A head segment of the main micro channel is communicated with a first fluid outlet; and the two secondary micro channels are located at two sides of the main micro channel and intersect with the main micro channel at an intersection in a cross-junction structure or a Y-junction structure, head segments of the two secondary micro channels separately correspond to and are communicated with two second fluid outlets, and tail ends of the hybrid micro channel have output ends. A slope is formed in a channel bottom surface of the main micro channel or the two secondary micro channels, and the slope is an ascending slope from a front segment of the slope to a rear segment of the slope, so that a channel of the slope has a depth change.

In an embodiment, the liquid leading-in plate comprises a fluid leading-in layer and an inlet channel layer. The fluid leading-in layer comprises a main injecting channel and a secondary injecting channel, where the main injecting channel has a first fluid injecting inlet and a first fluid outlet, the secondary injecting channel has a second fluid injecting inlet, a pair of sub-channels divided by the second fluid injecting inlet, and two second fluid outlets at tail ends of the sub-channels, and the first fluid injecting inlet and the second fluid injecting inlet are respectively used to inject first fluid and second fluid. The inlet channel layer is located below the fluid leading-in layer and is provided with a first fluid transmission channel and second fluid transmission channels respectively corresponding to the first fluid outlet and the second fluid outlets. Therefore, after being injected into the first fluid injecting inlet, the first fluid is sent out directly from the first fluid outlet, and is carried by the first fluid transmission channel of the inlet channel layer. After being injected into the second fluid injecting inlet, the second fluid is split by a sub-channel to the two second fluid outlets to be sent out, and is separately carried by two second fluid transmission channels of the inlet channel layer.

In an embodiment, the microsphere leading-out plate comprises a microsphere transmission channel, where a head end thereof is a micro sphere inlet, a tail end thereof has a micro sphere outlet, and the micro sphere inlet is communicated with the output end of the hybrid micro channel.

In an embodiment, the fluid leading-in layer comprises no more than three fluid injecting inlets comprising the first fluid injecting inlet and the second fluid injecting inlet.

In an embodiment, a structure for combining the liquid leading-in plate, the main micro channel layer, and the microsphere leading-out plate is fastened by using screws in a centralized and closely pressing manner.

In an embodiment, a path of the microsphere transmission channel is provided with a UV light hole, so as to use UV light to illuminate a cut-off microsphere passing through the micro sphere transmission channel.

In an embodiment, an observation hole is provided at a position, on the micro sphere leading-out plate, corresponding to the microsphere transmission channel or the hybrid micro channel of the main micro channel layer, so as to observe a microsphere generation state.

The present invention has at least the following characteristics that: an inclined inlet is designed before a main micro channel and/or two secondary micro channels intersects in a hybrid channel, to form a micro channel that is from being deep to being shallow, thereby (1) having a pressure reducing effect and (2) reducing a contact area. In addition, for the foregoing design of the inclined inlet, a flow speed of injected fluid can be used and controlled to adjust a size of a microsphere particle obtained by cutting, thereby having the technical potentials of desirable controllability, high reaction efficiency, a short process time, a simple operation, a low cost, batch production, and expansion of small factories. In the present invention, a technology of high-strength and detachable micro channel packaging can be developed to improve the congestion problem of current glue packaged micro channels in the market. By using the foregoing technology in the present invention, a microsphere manufacturing apparatus can be developed, and a particle diameter of a manufactured smallest solid microsphere can be controlled under Φ 10 μm. In an embodiment, in the present invention, five liquid inlets used in the prior art are changed into three liquid inlets, and a three-way valve sold in the market to be used to diverge micro fluid is omitted, so as to control micro fluid more accurately. In the present invention, a UV light hole is added to a microsphere leading-out plate and a UV light source is embedded to directly perform UV light illumination, so that a micro sphere is solidified (hardening), so that, when surfaces of the microspheres are not completely hardened, the possibility that the unhardened microspheres generated in a flow process are mixed can be reduced. In the present invention, an observation hole for observing a micro channel is added to the microsphere leading-out plate, so that a microsphere generation state for micro fluid is easily observed.

### BRIEF DESCRIPTION OF THE DRAWINGS

FIG. 1 is a three-dimensional combination diagram in the prior art;

FIG. 2 is a three-dimensional combination diagram of an embodiment of a combined microsphere manufacturing apparatus according to the present invention;

FIG. 3 is a three-dimensional exploded diagram of a composition structure of each layer according to the embodiment in FIG. 2;

FIG. 4 is a three-dimensional diagram of a fluid leading-in layer of a liquid leading-in plate in an embodiment of a combined microsphere manufacturing apparatus according to the present invention;

FIG. 5 is a three-dimensional diagram of an inlet channel layer of a liquid leading-in plate in an embodiment of a combined microsphere manufacturing apparatus according to the present invention;

FIG. 6 is a three-dimensional diagram of a main micro channel layer in an embodiment of a combined microsphere manufacturing apparatus according to the present invention;

FIG. 7 is an enlarged partial view of a mark number 7 in FIG. 6;

FIG. 8 is a three-dimensional diagram of a microsphere leading-out plate in an embodiment of a combined microsphere manufacturing apparatus according to the present invention;

FIG. 9 is a schematic diagram of a front cross section showing a function of an inclined inlet micro channel of a main micro channel and a hybrid micro channel of a main micro channel layer on a flow speed of an injection fluid according to an embodiment of the present invention; and

FIG. 10 is a schematic diagram of a front cross section showing a function of an inclined inlet micro channel of a main micro channel and a hybrid micro channel of a main micro channel layer on flow speed of an injection fluid according to an embodiment of the present invention.

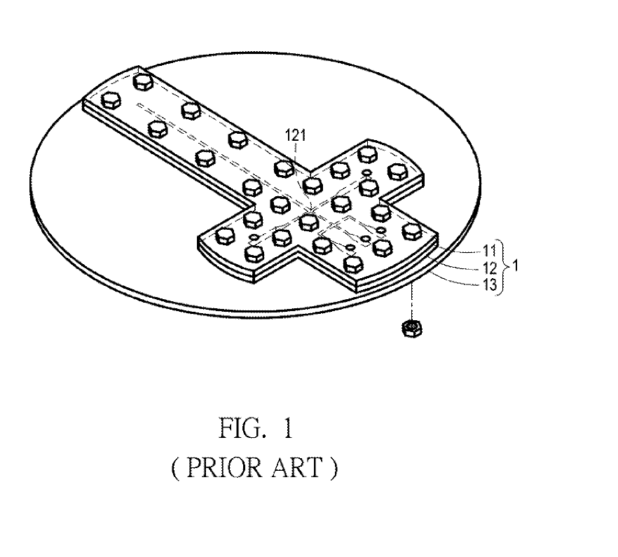

### DETAILED DESCRIPTION

Embodiments of the present invention are described below with reference to the accompanying drawings.

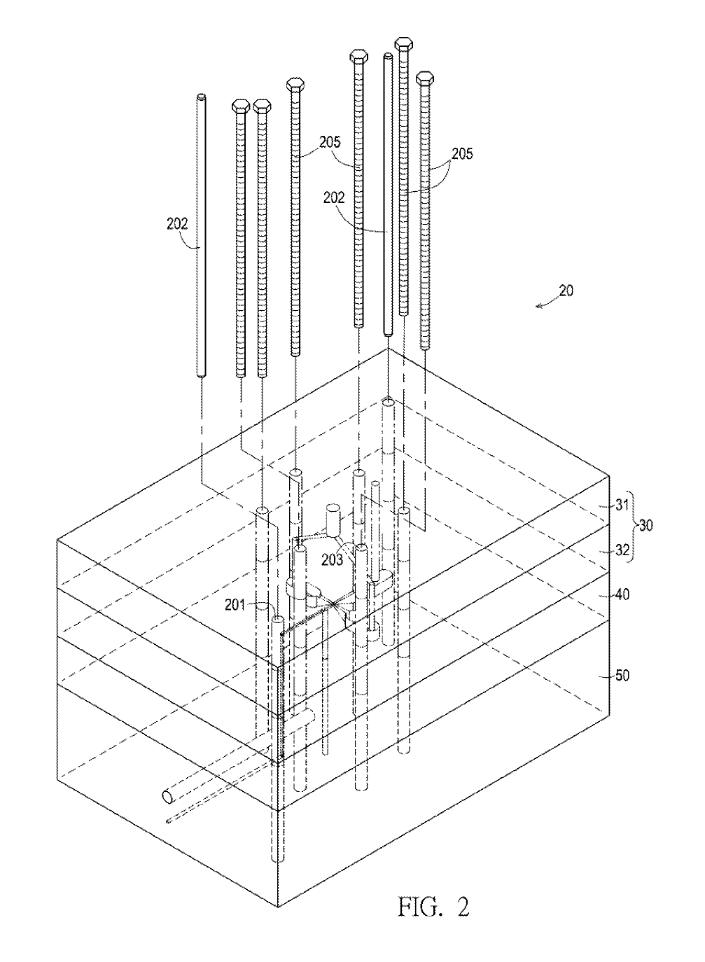

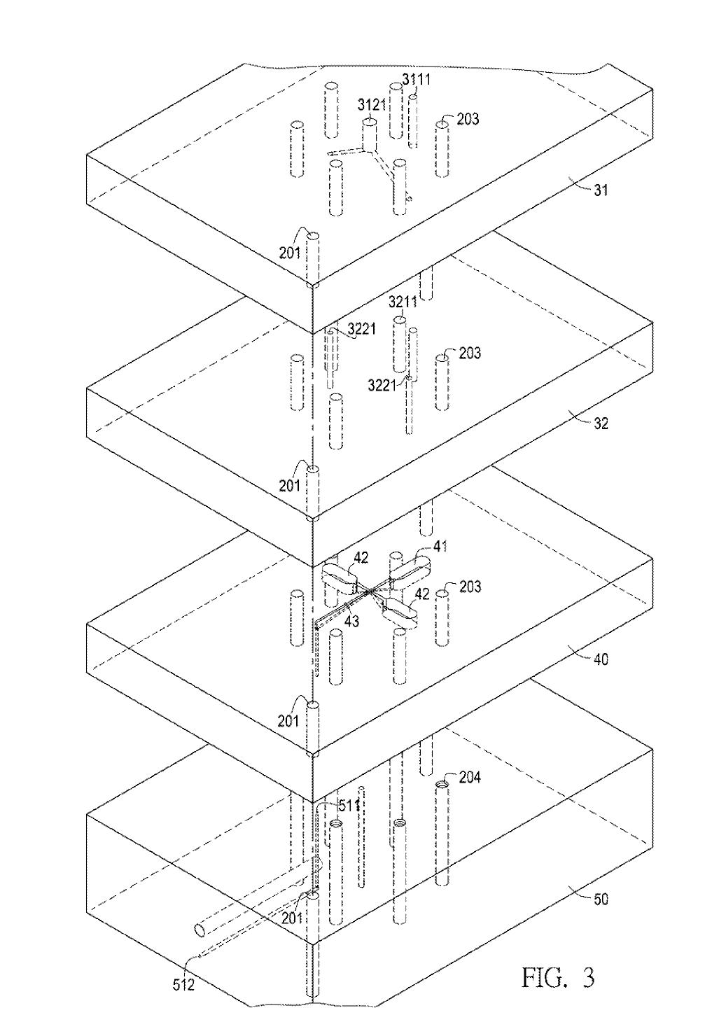

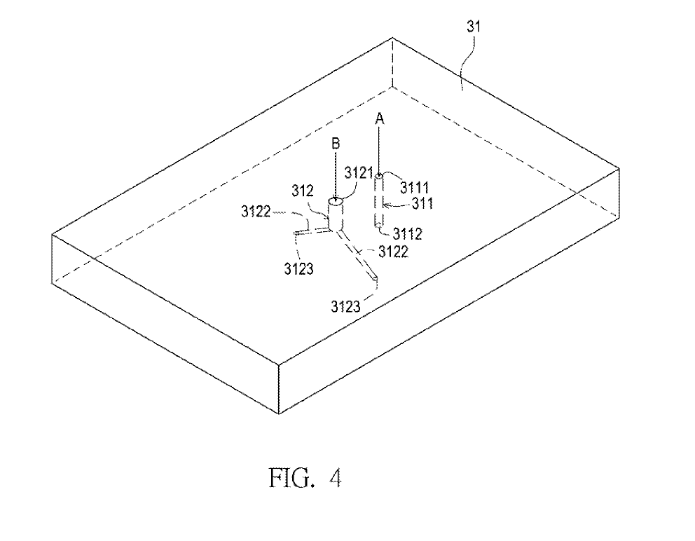

First refer to FIG. 2 and FIG. 3, and FIG. 4 to FIG. 10. A combined microsphere manufacturing apparatus 20 in an embodiment mainly includes a liquid leading-in plate 30, a main micro channel layer 40, and a microsphere leading-out plate 50. The liquid leading-in plate 30 is placed above the main micro channel layer 40 and the microsphere leading-out plate 50 is placed below the main micro channel layer 40 in a proper combination manner, to form the combined microsphere manufacturing apparatus 20 through stacking combination. In the foregoing combination manner, a pair of positioning holes 201 may be provided at corresponding positions of each layer, a positioning pin 202 is inserted for positioning, a locking hole 203 (a threaded hole 204 is on a bottom layer) for a screw to pass through is then provided on each layer, and a proper number of threaded rods 205 are used to fasten in a centralized and closely pressing manner, so that pressure is centralized on a cross-junction micro channel and layers are fastened together. In this embodiment, the liquid leading-in plate 30 is provided with a first fluid outlet 3111 and two second fluid outlets 3221. The microsphere leading-out plate 50 has a micro sphere inlet 511 and a micro sphere outlet 512.

Still refer to FIG. 4 (the positioning hole and the locking hole are omitted in FIG. 4). The liquid leading-in plate 30 in this embodiment includes a fluid leading-in layer 31 and an inlet channel layer 32. The fluid leading-in layer 31 includes a main injecting channel 311 and a secondary injecting channel 312, where the main injecting channel 311 has a first fluid injecting inlet 3111 and a first fluid outlet 3211, the secondary injecting channel 312 has a second fluid injecting inlet 3121, a pair of sub-channels 3122 divided by the second fluid injecting inlet 3121, and two second fluid outlets 3221 at tail ends of the sub-channels 3122, and the first fluid injecting inlet 3111 and the second fluid injecting inlet 3121 are respectively used to inject first fluid A and second fluid B.

The first fluid A is injected through the first fluid injecting inlet 3111, and the second fluid B is injected through the second fluid injecting inlet 3121. To conveniently control a flow speed, a programmable control pump (not shown in the figure) may be used to separately control flow speeds of the first fluid A and the second fluid B.

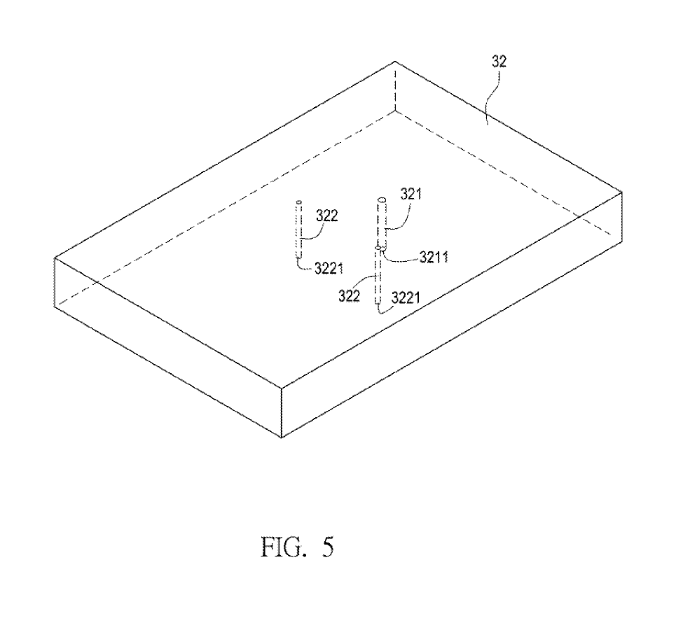

Still refer to FIG. 5 (the positioning hole and the locking hole are omitted in FIG. 5). The inlet channel layer 32 in this embodiment is located below the fluid leading-in layer 31 (shown in FIG. 4) and is provided with a first fluid transmission channel 321 and second fluid transmission channels 322 respectively corresponding to the first fluid outlet 3211 and the second fluid outlets 3221. The first fluid transmission channel 321 has the first fluid outlet 3211 and the second fluid transmission channels 322 have the second fluid outlets 3221.

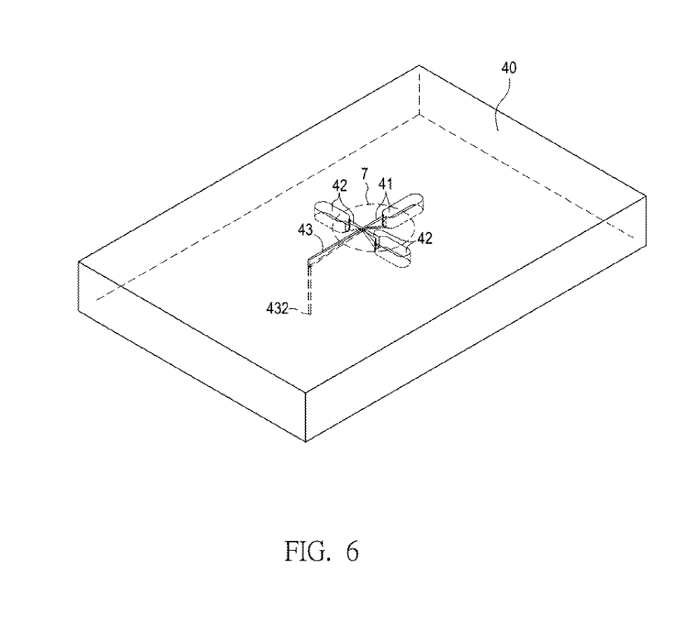

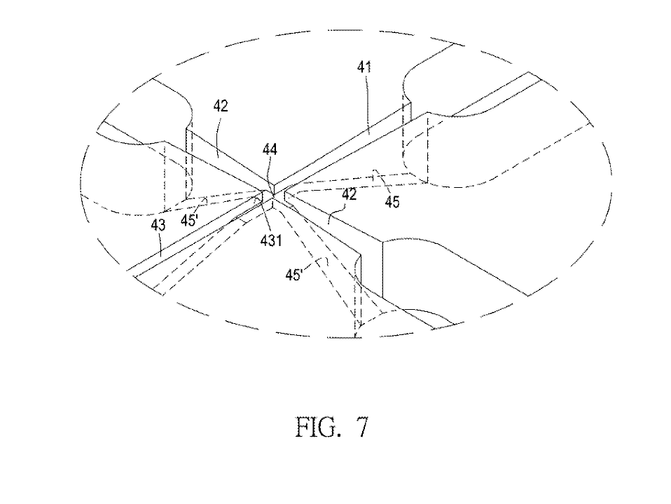

Still refer to FIG. 6 and FIG. 7 (the positioning hole and the locking hole are omitted in FIG. 6). The main micro channel layer 40 includes a main micro channel 41, two secondary micro channels 42, and a hybrid micro channel 43. A head segment of the main micro channel 41 corresponds to and is communicated with the first fluid outlet 3211 (shown in FIG. 5); the secondary micro channels 42 are located at two sides of the main micro channel 41 and intersect with the main micro channel 41 at an intersection 44 in a cross junction (certainly, a Y junction may also be configured, but this embodiment is based on the cross junction), and head segments of the two secondary micro channels 42 separately correspond to and are communicated with the two second fluid outlets 3221; and the hybrid micro channel 43 is located in a lower reach of the intersection 44, a head end of the hybrid micro channel 43 is connected to and starts from the intersection 44, and a tail end of the hybrid micro channel 43 has an output end 432. A channel bottom surface (45, 45′) of the main micro channel 41 and/or the two secondary micro channels 42 includes a slope F, and the slope F is an ascending slope from a front segment of the slope F to a rear segment of the slope F, so that a channel (the main micro channel 41 or the two secondary micro channels 42) of the slope F has a depth change. Besides the fact that the channel bottom surface (45, 45′) of the main micro channel 41 and/or the secondary micro channels 42 has a slope change, further, a junction of a cross section from the head segment (411, 421) of the main micro channel 41 and/or the secondary micro channels 42 to the intersection 44 changes from being wide and deep to being narrow and shallow.

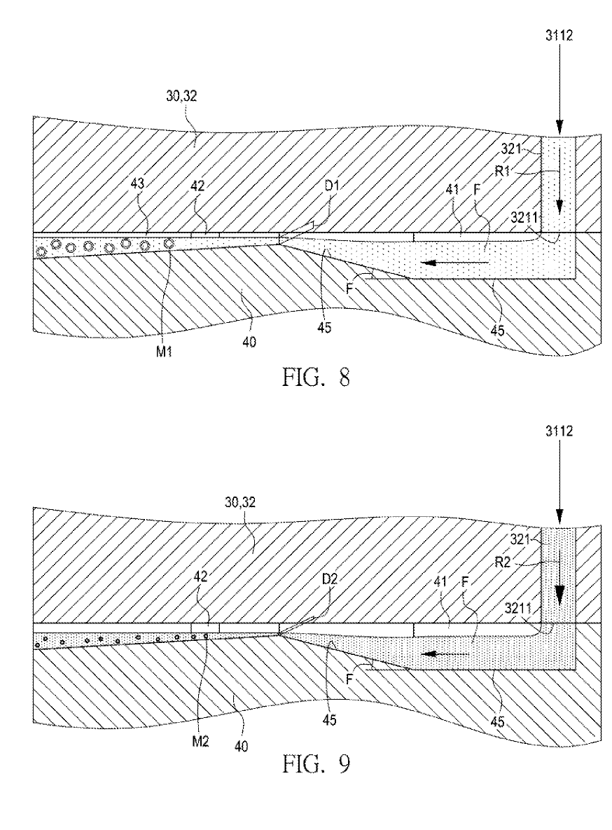

Therefore, as shown in FIG. 8, according to the foregoing descriptions, when the first fluid A is controlled at a flow speed R1, when the first fluid A flows through the slope F and passes through the intersection 44, a first fluid A amount with a caliber D1 may be formed, and a size of a micro sphere M1 that can be manufactured is relatively large. As shown in FIG. 9, when the first fluid A is controlled at a flow speed R2, when the first fluid A flows through the slope F and passes through the intersection 44 (intersection with the secondary injecting channel 312), a first fluid A amount with a caliber D2 may be formed, and a size of a microsphere M2 that can be manufactured is relatively small.

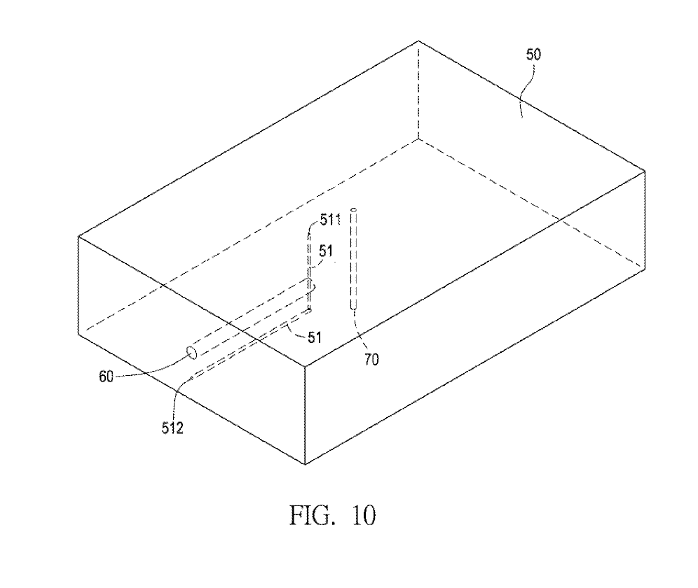

Still refer to FIG. 10 (the positioning hole and the threaded hole are omitted in FIG. 10). In this embodiment, the microsphere leading-out plate 50 includes a microsphere transmission channel 51, where a head end thereof is a microsphere inlet 511, a tail end thereof has a micro sphere outlet 512, and the micro sphere inlet 511 is communicated with the output end 432 of the hybrid micro channel 43 (shown in FIG. 6), so as to output a manufactured microsphere entering the hybrid micro channel 43 after passing through the main injecting channel 311 and the secondary injecting channel 312.

It should be noted that the fluid leading-in layer 31 in the present invention includes no more than three fluid injecting inlets including the first fluid injecting inlet 3111 and the second fluid injecting inlet 3121, so as to avoid that a three-way valve sold in the market is used to diverge micro fluid.

In addition, in an embodiment, sizes of the secondary micro channels in the cross-junction (or the Y-junction) structure have a length of 50 to 2000 μm, a width above 5 μm, and roughness below Ra0.3 μm, where 0.5 μm is added or subtracted for accuracy of the sizes.

Refer to FIG. 10. In an embodiment, the microsphere leading-out plate 50 is provided with a UV light hole 60, an end portion of the UV light hole 60 faces a path of the microsphere transmission channel 51, and a UV light apparatus (not shown in the figure) is arranged inside the UV light hole 60, so as to use UV light to illuminate a cut-off microsphere passing throughby the microsphere transmission channel 51. In addition, an observation hole 70 is provided on the microsphere leading-out plate 50. An end portion of the observation hole 70 faces a position of the micro sphere transmission channel 51 or the hybrid micro channel 43 of the main micro channel layer 40, and an image shooting apparatus (for example, a CCD camera, not shown in the figure) may be arranged inside the observation hole 70, so as to observe a microsphere generation state.

It should be noted that the liquid leading-in plate, the main micro channel layer, and the microsphere leading-out plate in the present invention are all manufactured by using materials with reactionlessness, for example:

In an embodiment, the fluid leading-in layer is manufactured by using an acrylic material.

In an embodiment, the inlet channel layer is manufactured by using a glass material or a quartz glass material.

In an embodiment, the main micro channel layer is manufactured by using a glass material, a quartz glass material, a stainless steel material, or an aluminum oxide material.

In an embodiment, the microsphere leading-out plate is manufactured by using an aluminum material or a stainless steel material.

In conclusion, the present invention at least has the following advantages that: an inclined inlet is designed before a main micro channel and/or two secondary micro channels intersects in a hybrid channel, to form a micro channel that is from being deep to being shallow, thereby (1) having a pressure reducing effect and (2) reducing a contact area. In addition, for the foregoing design of the inclined inlet, a flow speed of injected fluid can be used and controlled to adjust a size of a microsphere particle obtained by cutting, thereby having the technical potentials of desirable controllability, high reaction efficiency, a short process time, a simple operation, a low cost, batch production, and expansion of small factories. In the present invention, a technology of high-strength and detachable micro channel packaging can be developed to improve the congestion problem of current glue packaged micro channels in the market. By using the foregoing technology in the present invention, a microsphere manufacturing apparatus can be developed, and a particle diameter of a manufactured smallest solid microsphere can be controlled under Φ 10 μm. In an embodiment, in the present invention, five liquid inlets used in the prior art are changed into three liquid inlets, and a three-way valve sold in the market to be used to diverge micro fluid is omitted, so as to control micro fluid more accurately. In the present invention, a UV light hole is added to a microsphere leading-out plate and a UV light source is embedded to directly perform UV light illumination, so that a micro sphere is solidified (hardening), so that the possibility that microspheres that are not hardened and are generated in a flow process are mixed when surfaces of the microspheres are not completely hardened is reduced. In the present invention, an observation hole for observing a micro channel is added to the microsphere leading-out plate, so that a microsphere generation state for micro fluid is easily observed.

The foregoing implementation manners or embodiments of technical means used in the present invention are not intended to limit the implementation scope of the patent of the present invention. Equivalent changes and modifications made in consistent with meanings of the claims of the present invention or according to the patent scope of the present invention shall fall within the patent scope of the present invention.

What is claimed is:

1. A combined microsphere manufacturing apparatus, comprising a main micro channel layer assembled below a liquid leading-in plate and above a microsphere leading-out plate, wherein the liquid leading-in plate has a first fluid outlet and two second fluid outlets, the microsphere leading-out plate has a microsphere inlet and a microsphere outlet, and the main micro channel layer comprises:
a main micro channel, wherein a head segment thereof is communicated with the first fluid outlet;
two secondary micro channels, located at two sides of the main micro channel and intersecting with the main micro channel at an intersection in a cross-junction structure or a Y-junction structure, wherein head segments of the two secondary micro channels separately correspond to and are communicated with the two second fluid outlets; and
a hybrid micro channel, located in a lower reach of the intersection, wherein a head end of the hybrid micro channel is connected to the intersection, a tail end of the hybrid micro channel has an output end, and the output end corresponds to and is communicated with the microsphere inlet,
wherein a channel bottom surface of the main micro channel and/or the two secondary micro channels comprises a slope, and the slope is an ascending slope from a front segment of the slope to a rear segment of the slope, so that a channel of the slope has a depth change.

2. The combined microsphere manufacturing apparatus according to claim 1, wherein the liquid leading-in plate comprises:
a fluid leading-in layer, comprising a main injecting channel and a secondary injecting channel, wherein the main injecting channel has a first fluid injecting inlet and a first outlet, the secondary injecting channel has a second fluid injecting inlet, a pair of sub-channels divided by the second fluid injecting inlet, and two second outlets at tail ends of the sub-channels, and the first fluid injecting inlet and the second fluid injecting inlet are respectively used to inject first fluid and second fluid; and
an inlet channel layer, located below the fluid leading-in layer, provided with a first fluid transmission channel and second fluid transmission channels respectively corresponding to the first fluid outlet and the fluid second outlets, wherein the first fluid transmission channel has the first fluid outlet, and the second fluid transmission channels have the second fluid outlets.

3. The combined micro sphere manufacturing apparatus according to claim 1, wherein the microsphere leading-out plate comprises:
a microsphere transmission channel, wherein a head end thereof is the microsphere inlet, a tail end thereof is the micro sphere outlet, and the micro sphere inlet is communicated with the output end of the hybrid micro channel.

4. The combined microsphere manufacturing apparatus according to claim 2, wherein the microsphere leading-out plate comprises:
a microsphere transmission channel, wherein a head end thereof is the microsphere inlet, a tail end thereof is the micro sphere outlet, and the micro sphere inlet is communicated with the output end of the hybrid micro channel.

5. The combined micro sphere manufacturing apparatus according to claim 3, wherein the fluid leading-in layer comprises no more than three fluid injecting inlets comprising the first fluid injecting inlet and the second fluid injecting inlet.

6. The combined micro sphere manufacturing apparatus according to claim 1, wherein a junction of a cross section from the head segment of the main micro channel and/or the secondary micro channels to the intersection changes from being wide and deep to being narrow and shallow.

7. The combined microsphere manufacturing apparatus according to claim 1, wherein sizes of the secondary micro channels in the cross-junction or the Y-junction structure have a length of 50 to 2000 μm, a width above 5 μm, and roughness below Ra0.3 μm, wherein 0.5 μm is added or subtracted for accuracy of the sizes.

8. The combined micro sphere manufacturing apparatus according to claim 3, wherein a structure for combining the liquid leading-in plate, the main micro channel layer, and the microsphere leading-out plate is fastened by using screws in a centralized and closely pressing manner.

9. The combined micro sphere manufacturing apparatus according to claim 2, wherein the fluid leading-in layer is manufactured by using an acrylic material.

10. The combined micro sphere manufacturing apparatus according to claim 2, wherein the inlet channel layer is manufactured by using a glass material or a quartz glass material.

11. he combined microsphere manufacturing apparatus according to claim 8, wherein the inlet channel layer is manufactured by using a glass material or a quartz glass material.

12. The combined microsphere manufacturing apparatus according to claim 9, wherein the main micro channel layer is manufactured by using a glass material, a quartz glass material, a stainless steel material, or an aluminum oxide material.

13. The combined micro sphere manufacturing apparatus according to claim 10, wherein the microsphere leading-out plate is manufactured by using an aluminum material or a stainless steel material.

14. The combined microsphere manufacturing apparatus according to claim 3, wherein the micro sphere leading-out plate is further provided with a UV light hole, an end portion of the UV light hole faces a path of the microsphere transmission channel, and a UV light apparatus is arranged inside the UV light hole, so as to use UV light to illuminate a micro sphere cut off by the micro sphere transmission channel.

15. The combined micro sphere manufacturing apparatus according to claim 3, wherein an observation hole is provided at a position, on the microsphere leading-out plate, corresponding to the microsphere transmission channel or the hybrid micro channel of the main micro channel layer, and an image shooting apparatus is arranged inside the observation hole, so as to observe a microsphere generation state.
